(19) United States
(12) Patent Application Publication
(10) Pub. No.: US 2009/0094248 A1
(43) Pub. Date: Apr. 9, 2009

(54) SYSTEM AND METHOD OF PRIORITIZING THE DOWNLOADING OF MEDIA ITEMS IN A MEDIA ITEM RECOMMENDATION NETWORK

(75) Inventor: Steven L. Petersen, Los Gatos, CA (US)

Correspondence Address: CONCERT TECHNOLOGY AND WITHROW & TERRANOVA, 100 REGENCY FOREST DRIVE , SUITE 160, CARY, NC, 27518, US

(73) Assignee: CONCERT TECHNOLOGY CORPORATION, Durham, NC (US)

(21) Appl. No.: 11/866,775

(22) Filed: Oct. 3, 2007

(51) Int. Cl. G06F 17/30

(52) U.S. Cl. 707/10; 707/200

(57) ABSTRACT

A system and method of prioritizing the downloading of media items to different user devices in a media item recommendation system is disclosed. A media server prioritizes the downloading of a recommended media item according to when each user device needs to receive the recommended media item to satisfy a timing constraint. For example, the timing constraint may be the time before the media item is to be played in a playlist according to a media item recommendation scoring system. User devices having a more immediate timing need for receiving a media item download can be prioritized over user devices having a less immediate need for receiving a media item download. In this manner, the media server is more likely to provide timely media item downloads to all the different user devices.

### FIELD OF THE INVENTION

The present invention relates to prioritizing and optimizing the downloading of media items to different user devices in a media item recommendation network. Downloading is prioritized according to when the user devices need to receive recommended media items to satisfy a scheduled play or other use.

### BACKGROUND OF THE INVENTION

In recent years, there has been an enormous increase in the amount of digital media available online. As a result, media items have become more accessible to consumers. Due to the large amount of accessible digital media, recommendation technologies have emerged to assist users in identifying and navigating large databases of available media. Recommendations are useful to help users identify and select media items of interest for usage and/or play.

Media item recommendations can be provided to users in a number of ways. For example, recommendations may be provided between peer users in a social network. When a peer user desires to recommend a media item to a recipient user, a peer user device sends a recommendation message identifying the recommendation to a recipient user device. The recommendation message may be sent directly to the recipient user in a peer-to-peer messaging fashion. Alternatively, the recommendation message may be intercepted by a media item recommendation system and forwarded to the recipient user device. In either case, the recommendation message typically only contains identification information of the media item since copyright laws may prohibit distribution of the actual media item being recommended.

When the media item recommendation is received, the recipient user may be informed. The recipient user device may also place the received media item recommendation in the recipient user's playlist. The order of placement in the playlist may be determined by the recipient user. Alternatively, the order of placement in the playlist may be automatically determined according to a recommendation scoring system. In any case, the order of placement of the media item recommendation in the playlist may determine the order in which the recipient user device plays the recommended media item. As such, the recipient user must have access to the actual media item when it is played based on the corresponding media item recommendation's position in the playlist. If the recommended media item is already stored locally on the recipient user device, the media item is available. However, if the recommended media item is not stored locally on the recipient user device, the media item must be obtained. Typically, the recipient user device requests downloading of a non-locally stored media item from a service provider. The service provider may be adapted to handle download requests from a large number of user devices.

Ideally, the non-locally stored media item should be downloaded to the recipient user device in sufficient time to be available when the media item comes up for play on the playlist. Otherwise, the playlist may not operate as intended. This may hamper the desire by recipient users to participate in a media item recommendation system. There are a number of factors that may prevent the timely receipt of media item downloads by a recipient user device. For example, the service provider may already be responding to previously received download requests from other user devices. A heavy download request load may prevent the service provider from timely servicing incoming media item download requests. Further, a user device having a low-speed or intermittent network connectivity may not be able to timely receive a media item download even if the service provider was able to service the download request in a timely manner.

Accordingly, a need exists to provide a greater likelihood that user devices will timely receive media item downloads from service providers. This need exists in particular for media item recommendation systems where media item recommendations for non-locally stored media items are scheduled in a recipient user's playlist. If media items are not timely received, media item recommendation scoring and priority systems may be unintentionally defeated.

### SUMMARY OF THE INVENTION

The present invention is directed to a system and method of prioritizing the downloading of media items to different user devices in a media item recommendation system. A media server receives requests from different user devices to download recommended media items not locally stored on the user devices. Instead of servicing download requests simply on a first come, first serve basis, the media server prioritizes the downloading of recommended media items to the user devices. The media server prioritizes the downloading of the media items according to when each user device needs to receive the media item to satisfy a timing constraint. For example, the timing constraint may be the time before a media item in a playlist is played according to a media item recommendation scoring system. User devices having a more immediate timing need for receiving a recommended media item download can be prioritized over user devices having a less immediate need for receiving a media item download. In this manner, the media server is more likely to provide timely media item downloads to all the different user devices.

In one embodiment of the present invention, when a user device needs access to a non-locally stored media item, the user device sends a download request to the media server. The user device also provides the necessary time constraint to receive the media item from the media server. The time constraint is provided in a download prioritization message sent from the user device to the media server. The time constraint is the time by which the requested media item needs to be received by the user device to be available according to any scheduling of the media item at the user device. The user device determines the time constraint based on analyzing when the requested media item will be required, or an estimate thereof. The media server uses the received time constraint from the user device to determine a scheduling constraint for the requested media item. In one embodiment of the present invention, the scheduling constraint is the latest point in time for the media server to begin the downloading of the non-locally stored media item to the user device to accommodate its time constraint. The scheduling constraint is then used to prioritize and schedule the downloading of the requested media item within the existing download schedule for currently scheduled media item downloads.

The time constraint provided by the user device may be based on any timing or scheduling method or algorithm. In one embodiment, the time constraint is based on the estimated time remaining until the non-locally stored media item is to be played or used on the user device. The time constraint may be based on or a function of a ranking of the media item recommendation in a playlist.

In another embodiment of the present invention, the media server may determine a scheduling constraint based on or a function of the timing constraint to determine when to begin the downloading of the media item. The scheduling constraint may take into account other information that affects the priority for downloading. This information may include the user device's probable downloading time for the requested media item. The downloading time may be based on the size of the media item, the network connection data rate for the user device, or a combination of these factors. These factors may be used by the media server to determine or refine the scheduling of media item downloads to the user devices. For example, the media server may need to raise the priority of a user device having a lower downloading speed over other user devices having similar time constraints and higher downloading speeds.

Further, the media server may determine the scheduling constraint based on other factors present at the media server. For example, the media server may not have immediate access to a recommended media item. The media server may have to request the recommended media item from another source. This may increase downloading time to the user device beyond the time constraint and/or other scheduling factors present at the user device. Thus, the media server may schedule the download to begin sooner to compensate for additional downloading time to obtain a requested media item from another source.

In another embodiment of the present invention, downloading recommended media items to the user device may be optimized by including more than one media item download request in a single media item prioritization message. In this manner, the media server may schedule and prioritize the downloading of each recommended media item requested by processing the single media item prioritization message. If the media items were included in separate media item prioritization messages, the media server would have to process different media item prioritization messages for each recommended media item. This may involve more processing time by the media server. Also, if the user data connection is sufficient, the media server may further optimize the downloading of media items by simultaneously downloading more than one media item to the user device. As such, it should also be noted that while the present invention relates to prioritizing the downloading of recommended media items to different user devices, the present invention can also relate to prioritizing the downloading of multiple recommended media items to a single user device.

The media server may also be adapted to receive new download prioritization messages for already scheduled media item downloads. The new download prioritization messages may include updated time constraints based on changes at user devices. If the time constraint is shortened, for a particular user device, the media server may reschedule the recommended media item download for that user device to occur sooner in time. If the time constraint is lengthened, the media server may reschedule the recommended media item download for that user device to occur later in time. This would allow the media server to move up higher priority downloads in the downloading scheduling. There could be any number of factors at the user devices that could change time constraints for requested media item downloads. Changes could include, for example, changing the order of a requested media item recommendation in a playlist. As an additional example, changes could be based on a change in a user device's network capacity and/or downloading speed.

If the media server could not timely download a recommended media item to a user device, a missed media item recommendation may be noted for the media item. The user device may use this designation to make changes regarding the requested media item. For example, if the recommended media item is scheduled in a playlist, the user device may move the missed media item recommendation down in the playlist to lengthen the time constraint. The user device may then send a new download prioritization message with the updated time constraint to the media server. The media server can leave the previously scheduled download for the requested media item in place or reschedule the downloading of the requested media item according to the updated time constraint in the new download prioritization message.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 is a schematic diagram illustrating an exemplary media item recommendation system, wherein the downloading of non-locally stored media items to user devices may be scheduled and prioritized, according to one embodiment of the present invention;

FIG. 2 is a flow chart illustrating exemplary processes for scheduling and downloading non-locally stored media items to user devices, according to one embodiment of the present invention;

FIG. 3 illustrates an exemplary download prioritization message, according to one embodiment of the present invention;

FIG. 4 illustrates an exemplary requested media item list which may be included in the download prioritization message, according to one embodiment of the present invention;

FIG. 5 provides an exemplary time progression for processing a received download prioritization message, according to one embodiment of the present invention;

FIGS. 6A and 6B are flow charts illustrating additional detail of exemplary processes for scheduling and downloading non-locally stored media items to user devices, according to one embodiment of the present invention;

FIG. 7 illustrates an exemplary media item download prioritization database, according to one embodiment of the present invention;

FIG. 8 is a flow chart illustrating an exemplary process by which the user device may send a download prioritization message upon the occurrence of certain user device events, according to one embodiment of the present invention;

FIG. 9 illustrates an exemplary network connectivity graphical user interface (GUI) which allows a user to initially set and/or change the network connection of the user device, according to one embodiment of the present invention;

FIG. 10 is a block diagram illustrating exemplary components that may be included at the central server of FIG. 1, according to one embodiment of the present invention; and

FIG. 11 is a block diagram illustrating exemplary components that may be included in the user device of FIG. 1, according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention is directed to a system and method of prioritizing the downloading of media items to different user devices in a media item recommendation system. A media server receives requests from different user devices to download recommended media items not locally stored on the user devices. Instead of servicing download requests simply on a first come, first serve basis, the media server prioritizes the downloading of recommended media items to the user devices. The media server prioritizes the downloading of the media items according to when each user device needs to receive the media item to satisfy a timing constraint. For example, the timing constraint may be the time before a media item in a playlist is played according to a media item recommendation scoring system. User devices having a more immediate timing need for receiving a recommended media item download can be prioritized over user devices having a less immediate need for receiving a media item download. In this manner, the media server is more likely to provide timely media item downloads to all the different user devices.

In one embodiment of the present invention, when a user device needs access to a non-locally stored media item, the user device sends a download request to the media server. The user device also provides the necessary time constraint to receive the media item from the media server. The time constraint is provided in a download prioritization message sent from the user device to the media server. The time constraint is the time by which the requested media item needs to be received by the user device to be available according to any scheduling of the media item at the user device. The user device determines the time constraint based on analyzing when the requested media item will be required, or an estimate thereof. The media server uses the received time constraint from the user device to determine a scheduling constraint for the requested media item. In one embodiment of the present invention, the scheduling constraint is the latest point in time for the media server to begin the downloading of the non-locally stored media item to the user device to accommodate its time constraint. The scheduling constraint is then used to prioritize and schedule the downloading of the requested media item within the existing download schedule for currently scheduled media item downloads.

The time constraint provided by the user device may be based on any timing or scheduling method or algorithm. In one embodiment, the time constraint is based on the estimated time remaining until the non-locally stored media item is to be played or used on the user device. The time constraint may be based on or a function of a ranking of the media item recommendation in a playlist.

In another embodiment of the present invention, the media server may determine a scheduling constraint based on or a function of the timing constraint to determine when to begin the downloading of the media item. The scheduling constraint may take into account other information that affects the priority for downloading. This information may include the user device's probable downloading time for the requested media item. The downloading time may be based on the size of the media item, the network connection data rate for the user device, or a combination of these factors. These factors may be used by the media server to determine or refine the scheduling of media item downloads to the user devices. For example, the media server may need to raise the priority of a user device having a lower downloading speed over other user devices having similar time constraints and higher downloading speeds.

Further, the media server may determine the scheduling constraint based on other factors present at the media server. For example, the media server may not have immediate access to a recommended media item. The media server may have to request the recommended media item from another source. This may increase downloading time to the user device beyond the time constraint and/or other scheduling factors present at the user device. Thus, the media server may schedule the download to begin sooner to compensate for additional downloading time to obtain a requested media item from another source.

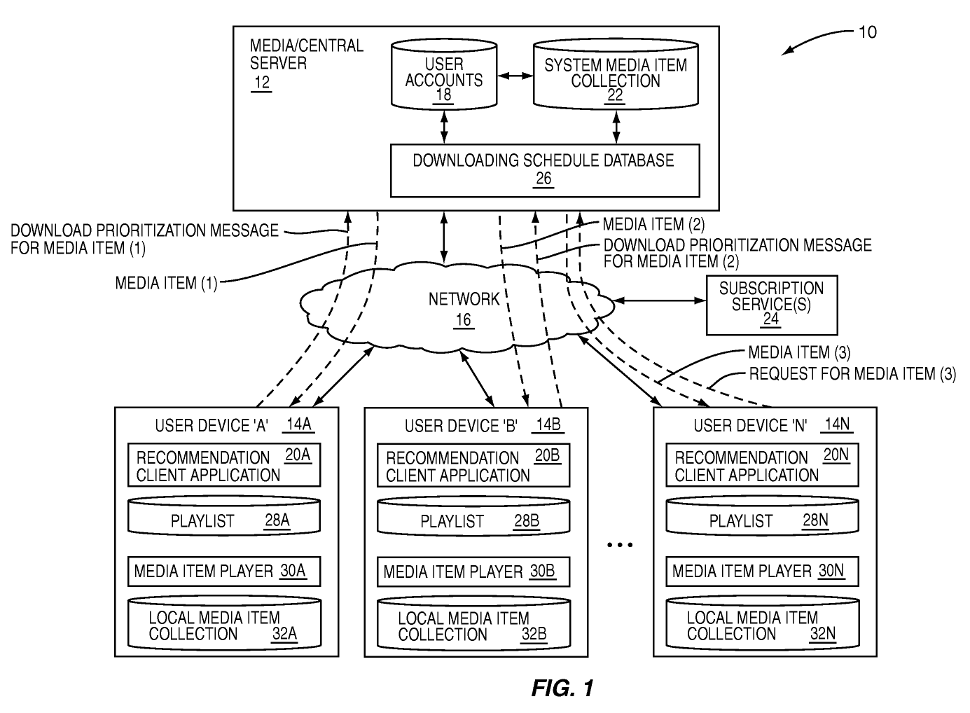

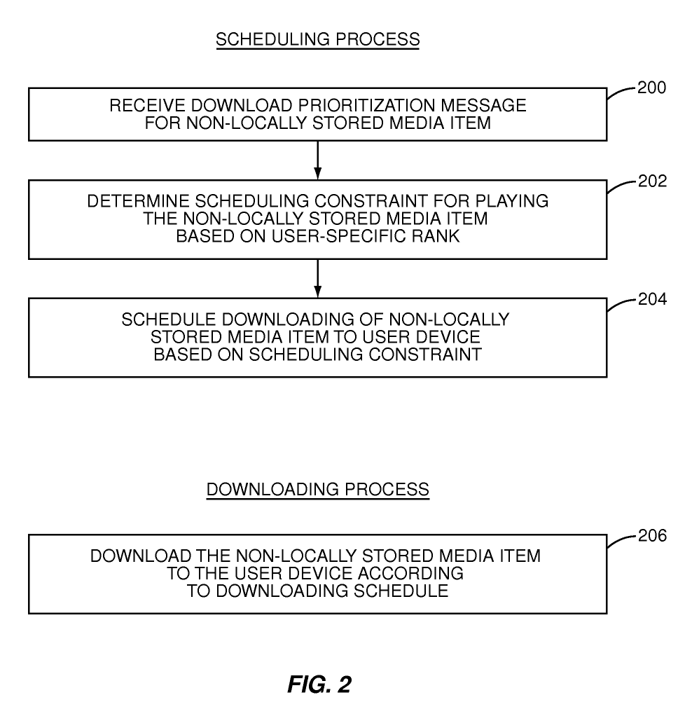

FIG. 1 illustrates an exemplary media item recommendation system 10 that may be employed by the present invention. The exemplary media item recommendation system 10 will be discussed first to provide a structure for the discussion of the process for prioritizing the downloading of the recommended media items. FIG. 2 begins the discussion of the process for prioritizing the downloading of recommended media items.

The media item recommendation system 10 has a media server in the form of a central server 12 that provides media-based services and manages the flow of information to users of the media item recommendation system 10. Accordingly, for purposes of describing the present invention, the central server 12 shall be understood to be a media server. The users in the media item recommendation system 10 may interact with the central server 12 using user devices 14. The central server 12 and the user devices 14 may communicate with each other and with other devices and systems over a network 16. The network 16 may be any private network or distributed public network such as, but not limited to, the Internet. In this manner, the users using the user devices 14 may register and establish an account with the media item recommendation system 10. The account and associated information may be recorded in a database of user accounts 18 in the central server 12. The user using the user device 14 may receive and download a recommendation client application 20 via the network 16. The recommendation client application 20 provides customized software allowing the central server 12 to provide media item services and information to the users and allowing the users to send and/or receive media item recommendations to and from other users. In this embodiment, the central server 12 operates in a client-server relationship, however, it should be noted that the present invention may be implemented in a peer-to-peer configuration. An example of a media item recommendation system that may be implemented in a user-server or peer-to-peer configuration is described in co-pending U.S. patent application Ser. No. 11/484,130, entitled “P2P NETWORK FOR PROVIDING REAL TIME MEDIA RECOMMENDATIONS,” filed Jul. 11, 2006, which is incorporated herein by reference in its entirety.

The central server 12 may comprise a system media item collection 22. The system media item collection 22 may contain non-locally stored media items which may be downloaded to the user devices 14. For purposes of the present invention, the non-locally stored media item may be any media item not stored in the user device 14 or some storage facility accessible to or by the user device 14. The central server 12 may download the non-locally stored media item to the user device 14 in response to a request for the non-locally stored media item received from the user device 14. If the system media item collection 22 does not contain the requested non-locally stored media item, the non-locally stored media item may be acquired from a subscription service 24 or other remote source (not shown). For purposes of the present invention, the subscription service 24 may be any market provider of media items.

The central server 12 may also include a downloading schedule database 26. The central server 12 may list the requested non-locally stored media items in the downloading schedule database 26. Accordingly, the downloading schedule database 26 may be used by the central server 12 to coordinate and/or facilitate the downloading of the non-locally stored media items to the respective user devices 14. Each of the non-locally stored media items may then be downloaded to the respective user devices 14 in the order the non-locally stored media items are listed in the downloading schedule database 26.

The central server 12 may list the requested non-locally stored media items in the downloading schedule database 26 in an order according to when the user device 14 may need the non-locally stored media item. The user device's 14 need for the non-locally stored media item may be based on or a function of the time remaining until the non-locally stored media item is scheduled to be played by the user device 14. The non-locally stored media item may be scheduled to be played by the user device 14 in an order according to the position in a playlist 28 of a media item recommendation corresponding to the requested non-locally stored media item.

The position in the playlist 28 of the media item recommendation may be a function of a ranking of the media item. The ranking may be based on a score or rating of the media item determined according to the user's preferences for that media item. Such preferences may relate to any attribute of the media item such as artist, genre, and date of release, for example. As such, the ranking may be considered a user-specific rank. In this regard, the media item recommendation in the first or top position in the playlist 28 corresponds to the media item having the highest user-specific ranking. The user device 14 may be programmed to automatically render and/or play the media item when the media item recommendation corresponding to the non-locally stored media item reaches the first or top position in the playlist 28. The user device 14 may play the non-locally stored media item using a media item player 30.

Rendering a media item may involve the user device 14 accessing the media item from a database or facility in which the media item may be stored. If the media item is not stored locally in a local media item collection 32, the user device 14 requests the non-locally stored media item from the central server 12. The central server 12 may schedule and prioritize the downloading of the non-locally stored media item to the user device 14 such that the non-locally stored media item may be directly accessible to and, therefore, available for the user device 14 to play at the scheduled time. To facilitate this timely downloading, the user device 14 may communicate a time constraint in a download prioritization message sent to the central server 12. The time constraint may be the amount of time remaining until the non-locally stored media item is scheduled to be played by or used on the user device 14. The central server 12 may use the information in the download prioritization message to determine a scheduling constraint. The scheduling constraint may be the latest point in time to begin downloading the non-locally stored media item such that the non-locally stored media item may be available for the user device 14 to play as scheduled. Accordingly, the scheduling constraint comprises the time constraint less the probable downloading time.

To further discuss the above-described process as applied to one non-locally stored media item, FIG. 2 is provided. Accordingly, FIG. 2 is a flow chart that illustrates exemplary processes that may be used by the central server 12 to schedule and download a non-locally stored media item to the user device 14, according to one embodiment of the present invention.

The scheduling process begins by receiving a download prioritization message for a non-locally stored media item (step 200). The download prioritization message may include a time constraint for the non-locally stored media item. The time constraint may be a function of the user-specific ranking of the non-locally stored media item. A scheduling constraint for playing the non-locally stored media item by a user device 14 may be determined as a function of the time constraint (step 202). The downloading of the non-locally stored media item to the user device 14 may then be scheduled for downloading as a function of the scheduling constraint (step 204). Once a non-locally stored media item is scheduled for downloading, the central server 12, directly and/or by or through another device or system, such as the subscription service 24 for example, may download the non-locally stored media item to the user device 14 according to the downloading schedule (step 206).

In this example, the downloading process in step 206 is shown as a separate process from scheduling in steps 200-204. By providing separate processes, the priority of the downloading process can be controlled separately from the scheduling process to minimize interruptions or delays in pending or in-progress downloads. Interruption or delay of downloading can introduce delay that may cause the central server 12 to not meet the timing constraint. If unacceptable delay or interruption occurs, the priority of the downloading process can be raised so that the control server 12 dedicates more processing time to the downloading process. Alternatively, the central server 12 can be designed to execute the downloading of non-locally stored media items as part of the scheduling process if desired. The computing power of the central server 12 may be such that a single process could perform all of these tasks without introducing delay that would cause time constraints to not be met. In any case, once the non-locally stored media item is downloaded, though, the non-locally stored media item may then be available for the user device 14 to play as scheduled.

The process discussed in FIG. 2 may be performed for each non-locally stored media item included in one or more prioritization messages. As an example, FIG. 1 shows that the user devices 14A, 14B each provide download prioritization messages to the central server 12. The user device 14A provides a download prioritization message involving non-locally stored media item (1) and the user device 14B provides a download prioritization message involving non-locally stored media item (2). Using the information in the respective download prioritization messages, the central server 12 may then determine the scheduling constraint for the non-locally stored media item (1) for the user device 14A, and the scheduling constraint for the non-locally stored media item (2) for the user device 14B. The central server 12 may then list the non-locally stored media item (1) and the non-locally stored media item (2) in the downloading schedule database 26 in the order of the most immediately needed non-locally stored media item based on their respective scheduling constraints. In other words, using the scheduling constraints, a priority for the non-locally based media item (1) may be determined and a priority for the non-locally stored media item (2) may be determined. The determined priorities may be compared and the non-locally stored media items may be listed in the downloading schedule 26, and thereby be scheduled for downloading based on the comparison.

If the non-locally stored media item (1) has the shortest scheduling constraint and, therefore, is needed by the user device 14A before the non-locally stored media item (2) is needed by the user device 14B, the non-locally stored media item (1) is listed as first priority in the downloading schedule database 26. The non-locally stored media items may then be downloaded according to their positions in the downloading schedule database 26. As such, the non-locally stored media item (1) may be downloaded to the user device 14A before the non-locally stored media item (2) is downloaded to the user device 14B.

Because the user device 14N in FIG. 1 has provided only a request for a non-locally stored media item (3) but not a download prioritization message, the central server 12 may schedule the downloading of the non-locally stored media item (3) subject to the prioritization of the downloading of the non-locally stored media item (1) and the non-locally stored media item (2). As such, the central server 12 may list the non-locally stored media item (3) last in the downloading schedule database 26 after the non-locally stored media item (1) and the non-locally stored media item (2). In other words, the central server 12 may respond to the scheduling constraints determined from the download prioritization messages before responding to a request for a non-locally stored media item.

Additionally, the central server 12 may process each download prioritization message in the order in which the central server 12 receives that download prioritization message. For example, if the central server 12 received the download prioritization message from the user device 14A before the download prioritization message from the user device 14B, the central server 12 may process the download prioritization message from the user device 14A first.

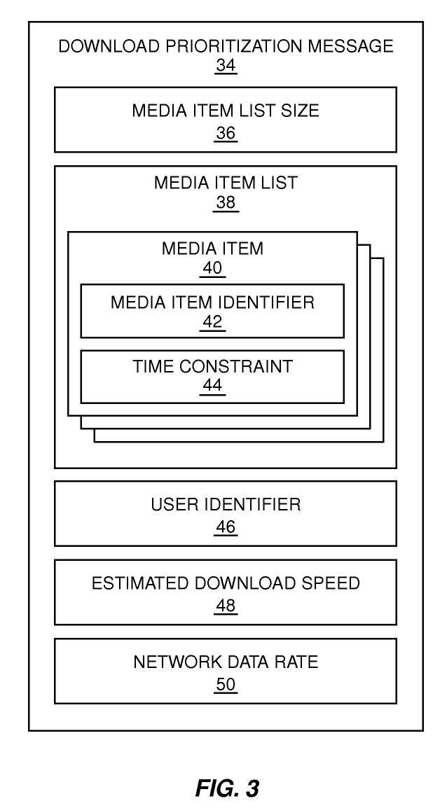

FIG. 3 illustrates an exemplary download prioritization message 34, according to one embodiment of the present invention. FIG. 3 is provided to describe and discuss a structure of the exemplary download prioritization message 34. The download prioritization message 34 may be used to communicate the time constraints for playing the non-locally stored media items and the estimated download speed of the user device 14, along with other information to the central server 12.

The download prioritization message 34 may include a media item list size 36 and a media item list 38. The media item list 38 may include one or more media items 40. The media items 40 may be the non-locally stored media items the user device 14 is requesting for downloading. Accordingly, the media item list size 36 may indicate that one media item 40 is included in the media item list 38, for example by indicating “1.” Alternatively, the media item list size 36 may indicate that multiple media items 40, such as the top five user-specified ranked media items 40 for example, are included in the media item list 38 by indicating “5.” In this manner, information is communicated to the central server 12 indicating that processing the download prioritization message 34 may involve determining the scheduling constraints for a certain number of media items 40.

The media items 40 may have a unique media item identifier 42 and a time constraint 44. The time constraint 44 may be the amount of time remaining until the media item recommendation corresponding to that particular non-locally stored media item 40 reaches the top of the playlist 28. Therefore, the time constraint 44 may be the amount of time remaining until the user device 14 is to play the non-locally stored media item 40. In other words, the time constraint 44 may be the amount of time before the non-locally stored media item 40 is to be used on the user device 14.

The time constraint 44 may be computed by adding the time remaining for the media item 40 currently playing on the user device 14 and the time for any media item 40 in the playlist 28 that is ranked higher than that non-locally stored media item 40. If the user device 14 needs the non-locally stored media item 40 immediately, the time constraint 44 may be set at “0.” It should be noted that the time constraint 44 is a relative value such that synchronization between the central server 12 and the user device 14 is not required. This assumes that the transmission time for sending the download prioritization message 34 from the user device 14 to the central server 12 over the network 16 is near-instantaneous, which may be assumed for purposes of this embodiment of the present invention.

The download prioritization message 34 may also include a user identifier 46. The user identifier 46 may be any unique identifier identifying the user device 14 that sent the download prioritization message 34. The central server 12 may use the user identifier 46 for determining which of the user devices 14 sent the download prioritization message 34. Additionally, the download prioritization message 34 may include an estimating download speed 48 of the user device 14. The user device 14 may compute the estimated download speed 48 by taking a recent time-weighted average of the download speeds of previously downloaded media items. The central server 12 may then use the estimated download speed 48 and the time constraint 44 to determine the scheduling constraint. As discussed above, the central server 12 may use the scheduling constraint to schedule and prioritize the downloading of the non-locally stored media item 40 to the user device 14.

The download prioritization message 34 may also include an indication of a network data rate 50 for the user device's 14 network connection and/or specify the network connection. In this regard, examples of the network connection for the user device 14 may include, but are not limited to, Dial-up, Cellular Data, DSL/Cable, WiFi, GPRS, EDGE, or 3G. The central server 12 may use the information to determine whether more than one non-locally stored media item 40 may be downloaded to the user device 14 at a time. Therefore, by using the network data rate 50 for the user device's 14 network connection, the central server 12 may optimize the use of the download prioritization message 34 by simultaneously downloading more than one non-locally stored media item 40 to the user device 14.

If two or more non-locally stored media items 40 need to be requested for downloading by the user device 14, the media item 40 download requests can be included in a single download prioritization message 34. As an example, if two non-locally stored media items 40 are listed back-to-back in the playlist 28, both non-locally stored media items 40 may be included in the same download prioritization message 34. Providing more than one non-locally stored media item 40 in the download prioritization message 34 may further optimize the use of the download prioritization message 34. In this way, the central server 12 may schedule and prioritize the downloading of the non-locally stored media items 40 listed in the download prioritization message 34 without having to process multiple download prioritization messages 34 (i.e. one for each non-locally stored media item 40). This saves processing time by the central server 12 not having to process multiple download prioritization messages 34. This may be particularly beneficial if the non-locally stored media items 40 have very close time constraints. For example, if two download prioritization messages 34 are used to request downloading of two non-locally stored media items 40, the central server 12 may not be able to process the second download prioritization message 34 before the second of the two non-locally stored media items 40 is to be played.

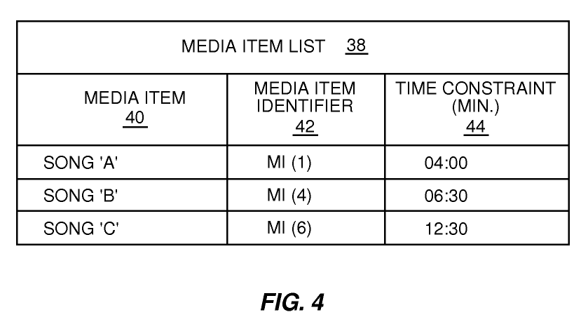

FIG. 4 illustrates an exemplary media item list 38 which may be included in the download prioritization message 34, according to one embodiment of the present invention. FIG. 4 is provided to show how the user device 14 may request multiple non-locally stored media items 40 in the media item prioritization message 34 and the time constraint 44 for each of the non-locally stored media items 40.

The media item 40 with the shortest time constraint 44 is listed first and then followed in order by the media items 40 as a function of the time constraints 44. In this manner, Song ‘A’ is listed first or at the top of the media item list 38, with the media item identifier 42 “MI (1)” and a time constraint 44 of 04:00 (four minutes). Song ‘B’ with a media item identifier 42 “MI (4)” and a time constraint 44 of 06:30 (six minutes, thirty seconds) is listed followed by Song ‘C’ with the media item identifier 42 of “MI (6)” and a time constraint 44 of 12:30 (twelve minutes, thirty seconds). Although the media item identifier 42 is shown as “MI” with a number in parentheses, the media item identifier 42 may be any unique identifier including, but not limited to, an alphanumeric format or progression comprising and/or referring to a known fingerprint and/or Globally Unique Identifier (GUID) of the non-locally stored media item 40.

Additionally, the media item list 38 includes the media items 40 with media item identifiers 42 “MI (1),” “MI (4),” and “MI (6).” The media item list 38 does not include media item identifiers 42 “MI (2),” “MI (3),” and “MI (5).” This could have resulted from media item identifiers 42 “MI (2),” “MI (3),” and “MI (5)” representing media items 40 already stored locally on the user device 14A. Thus, these media items 40 represented by media item identifiers 42 “MI (2),” “MI (3),” and “MI (5)” do not need to be requested for downloading.

The time constraints 44 shown in the media item list 38 may be relative to the user device 14 that sent the download prioritization message 34. The central server 12 then may have to convert the time constraint 44 to a server absolute time. In this manner, all of the time constraints 44 may be aligned to the same time standard to allow the central server 12 to process each download prioritization message 34 and determine each scheduling constraint according to a coordinated time basis.

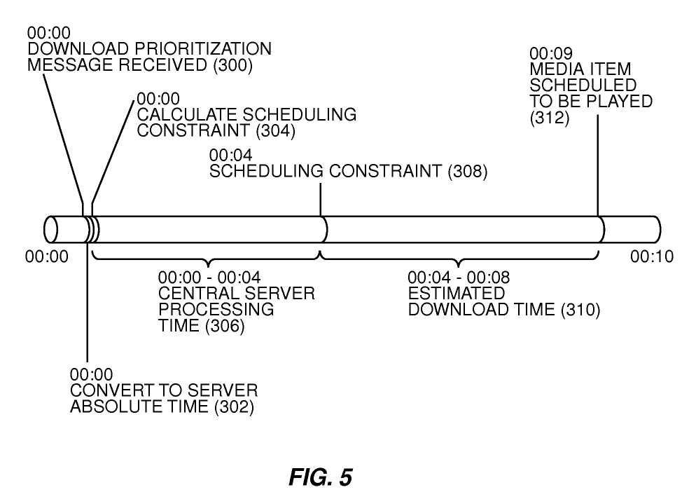

FIG. 5 illustrates a timeline for the different functions performed by the central server 12 upon receipt of the download prioritization message 34 for the non-locally stored media item 40 according to one embodiment of the present invention. FIG. 5 shows how the central server 12 determines the scheduling constraint using the time constraint 44 and other information to determine when to begin downloading a non-locally stored media item 40.

The process and the timeline may begin when the central server 12 receives and time stamps the download prioritization message 34 “00:00” (300). Upon receipt of the download prioritization message 34, the central server 12 converts the time constraint 44 to server absolute time (302) and, using the server absolute time, calculates the scheduling constraint (304). The central server 12 calculates the scheduling constraint by subtracting an estimated downloading time for the non-locally stored media item 40 from the server absolute time. The central server 12 then accounts for any time involving the scheduling constraint calculation and any other internal processing, which is shown as between time points “00:00” and “00:04” (306). The scheduling constraint may then be the latest point in time when downloading may begin taking into account the estimated downloading time “00:04” (308). The estimated downloading time may vary for different non-locally stored media items 40 and, therefore, is shown as extending between time points “00:04” and “00:08” (310). Accordingly, the scheduling constraint is an “as-late-as-possible” time to begin the downloading of the non-locally stored media item 40, such that the downloading to the user device 14 is completed and the non-locally stored media item 40 is available for the user device 14 to play at the scheduled time, which is shown as “00:09” (312). Accordingly, the downloading of the non-locally stored media item 40 may begin at any time prior to the scheduling constraint to support the scheduled time of playing the non-locally stored media item 40. The time periods shown in FIG. 5 for the different functions of the central server 12 are exemplary only and, accordingly, the present invention is not limited to any particular time periods.

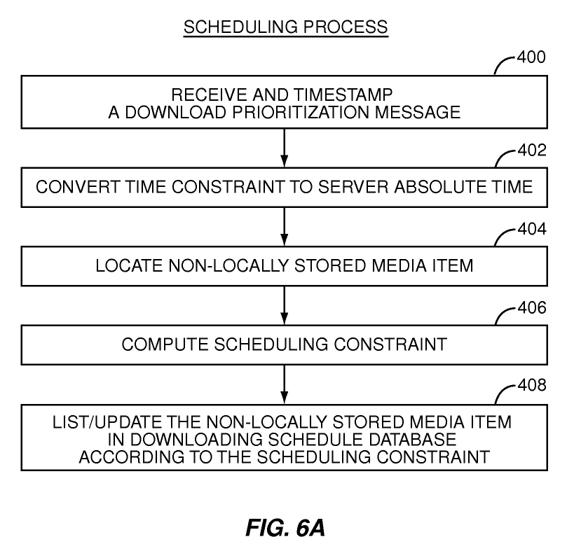

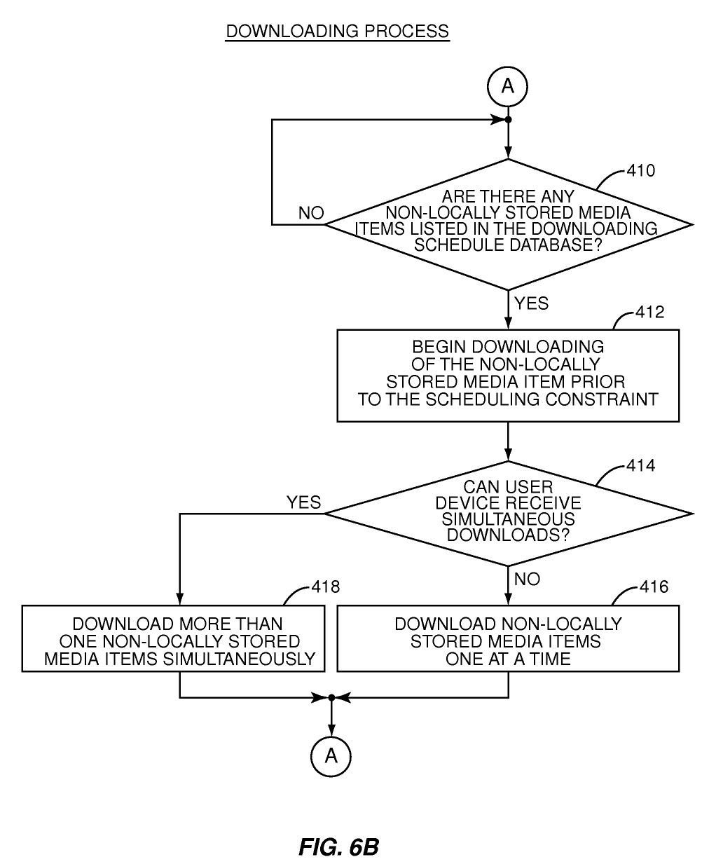

To further discuss the functions of the central server 12, FIGS. 6A and 6B are provided. FIGS. 6A and 6B further illustrate and provide more detail regarding the process described in FIG. 5 with respect to processing the download prioritization message 34, according to one embodiment of the present invention.

The scheduling process illustrated in FIG. 6A is a more detailed exemplary process of the scheduling process illustrated by steps 200-204 of FIG. 2, previously discussed. FIG. 6A begins with receiving and time stamping a download prioritization message 34 for a non-locally stored media item 40 (step 400). The download prioritization message 34 may include a time constraint 44 for the non-locally stored media item 40. Time stamping the download prioritization message 34 allows the time constraint 44 to be converted to a server absolute time (step 402). The non-locally stored media item 40 may then be located (step 404). The non-locally stored media item 40 may be located in the system media item collection 22, the subscription service 24, or remote media source.

A scheduling constraint may then be computed (step 406). The scheduling constraint may be computed by subtracting an estimated downloading time for the non-locally stored media item 40 from the server absolute time. The estimated downloading time may be calculated by dividing the non-locally stored media item 40 size by the estimated download speed 48. The non-locally stored media item 40 may then be listed in the downloading schedule database 26 along with other non-locally stored media items 40. The non-locally stored media items 40 may be listed in the downloading schedule database 26 in a priority according to each non-locally stored media item's 40 scheduling constraint (step 408). The non-locally stored media item 40 with the tightest or most immediate scheduling constraint has the highest priority and thus may be listed first followed in sequence by other non-locally stored media items 40 based upon their scheduling constraints. As such, the non-locally stored media item 40 with the loosest or least immediate scheduling constraint may have the lowest priority and be listed last.

The central server 12 is also adapted to receive a new download prioritization message 34 with a new or updated time constraint 44 for a previously requested non-locally stored media item 40 (step 408). For example, a non-locally stored media item 40 requested for download in a previous download prioritization message 34 may have not been successfully downloaded to the user device 14 according to the scheduling constraint. In this case, the user device 14 may move the media item recommendation down in a media item queue and determine a new or updated time constraint 44 for the non-locally stored media item 40. The user device 14 may then send the updated time constraint 44 to the central server 12 in a new download prioritization message 34. In this instance, instead of creating a new listing for the non-locally stored media item 40 in the downloading schedule database 26, the central server 12 may determine a new or updated scheduling constraint as a function of the updated time constraint 34. The central server 12 may then determine an updated priority for the downloading of the non-locally stored media item 40. The central server 12 can update the priority by simply modifying the order of the existing listing of the non-locally stored media item 40 in the downloading schedule database 26 according to the new scheduling constraint.

In any case, the non-locally stored media item 40 is listed in the downloading schedule database 26 such that it will be downloaded to the user device 14 by the downloading process in the order listed (i.e. its priority).

FIG. 6B is a more detailed exemplary process of the downloading process illustrated by step 206 of FIG. 2, previously discussed. As part of the downloading process, a determination may be made whether there are any non-locally stored media items 40 listed in the downloading schedule database 26 (decision point 410). This determination may be implemented as either a poll-based or interrupt-driven process for example. If there are non-locally stored media items 40 in the downloading schedule database 26, the non-locally stored media item 40 with the highest priority may begin downloading prior to that non-locally stored media item's 40 scheduling constraint (step 412).

A determination may next be made whether the user device 14 may be able to receive simultaneous downloading of more than one non-locally stored media item 40 based on that user device's 14 network data rate 50 (decision point 414). If the user device 14 is not able to receive simultaneous downloading of more than one non-locally stored media item 40, the non-locally stored media items 40 may be downloaded one at a time (step 416). Alternatively, if the user device 14 is able to receive simultaneous downloading of more than one non-locally stored media item 40, more than one of the non-locally stored media items 40 may be downloaded simultaneously to the user device 14, based on the network data rate 50 (step 418). Downloading the non-locally stored media items 40 may ensure that non-locally stored media items 40 are available for the user device 14 to play as scheduled. After downloading the non-locally stored media items 40, either one at a time (step 416) or simultaneously (step 418), the process returns to step 410 to continue to monitor the downloading schedule database 26 to initiate downloading of any pending non-locally stored media items 40.

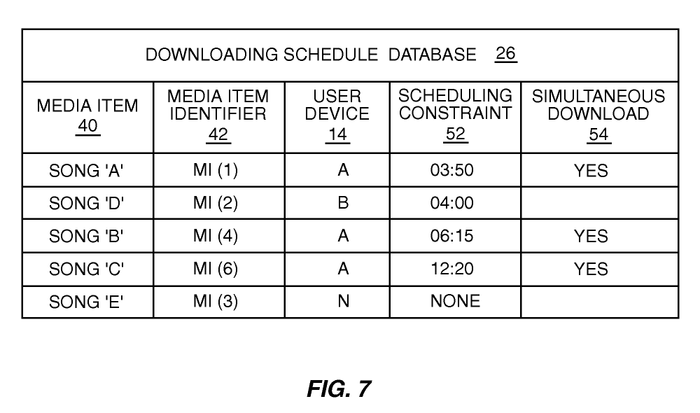

As discussed above, the non-locally stored media items 40 are listed in the downloading schedule database 26. To discuss this aspect in more detail, FIG. 7 is provided. Accordingly, FIG. 7 illustrates an exemplary downloading schedule database 26, according to one embodiment of the present invention. The non-locally stored media items 40 may be positioned in the downloading schedule database 26 in an order according to need, with the most immediately needed or highest priority non-locally stored media item 40 positioned first. In this manner, the central server 12 may cause the downloading of the non-locally stored media items 40 according to their position in the downloading schedule database 26 and, therefore, according to their respective priority.

The downloading schedule database 26 lists the titles of the non-locally stored media items 40 with the associated media item identifier 42, the user device 14 that requested or sent the download prioritization message 34 for the non-locally stored media item 40, a scheduling constraint 52 for each non-locally stored media item 40, and a simultaneous download indication 54. The simultaneous download indication 54 indicates whether the non-locally stored media item 40 may be downloaded simultaneously with other non-locally stored media items 40. The format of FIG. 7 is only for purposes of explaining this embodiment of the present invention, and accordingly, the present invention is not limited to any particular format for or structure of the downloading schedule database 26.

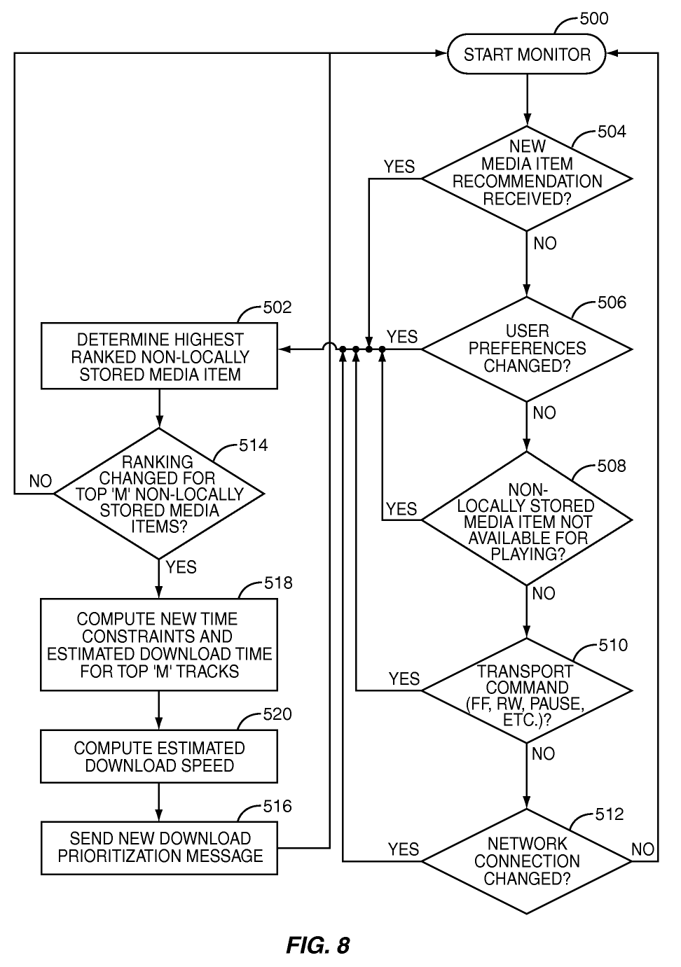

The download prioritization message 34 may be received from the user device 14 at any time and/or at the time of certain events. These events may include any event that changes and/or affects the user-specific rank, time constraints 44, and estimated download speed 48 of the non-locally stored media item 40. The occurrence of these events may change the scheduling constraint, and accordingly, the time the central server 12 may begin the downloading of the non-locally stored media item 40. If the scheduling constraint changes, the central server 12 may need to re-prioritize the downloading of the non-locally stored media items 40 to the different user devices 14. Accordingly, if there is such an event, a new download prioritization message 34 may be sent asynchronously by the user device 14 to the central server 12. The new download prioritization message 34 may have updated information related to the user-specific ranking, the time constraints 44, and/or the estimated download speed 48. From the new download prioritization message 34, an updated scheduling constraint 52 and an updated priority for the non-locally stored media item 40 may be determined. FIG. 8 is a flow chart illustrating the process by which the user device 14 may send the download prioritization message 34 upon the occurrence of such events, according to one embodiment of the present invention.

The process may begin by starting a monitor for determining the occurrence of certain events (step 500). Accordingly, the steps of the process may be based on a series of decision points. The decision points may be sequenced in a manner such that if the event of that decision point occurred, the highest ranked non-locally stored media item may again be determined (step 502). Alternatively, if the event of that decision point did not occur, the process may move to the next decision point in the sequence.

The first decision point in the sequence may be a determination whether a new media item recommendation is received (decision point 504). If a new media item recommendation was received, the new media item recommendation may be scored and a user-specific ranking may be associated with the media item being recommended. The new media item recommendation may then be positioned in the playlist 28 based on the user-specific ranking. The new media item recommendation may then change the positions of the other media item recommendations in the playlist 28. The changing of positions may change the position of the media item recommendation corresponding to the non-locally stored media item 40 with the highest user-specific ranking. Therefore, the highest ranked non-locally stored media item 40 may be determined based on the receipt of the new media item recommendation (step 502).

If a new media item recommendation was not received, the monitor may then determine whether the user preferences changed (decision point 506). Because the user-specific ranking may be based on the user preferences, if the user preferences change, the position of one or more media item recommendations in the playlist 28 may change. This may change the position of the media item recommendation corresponding to the non-locally stored media item 40 with the highest user-specific ranking. Therefore, the highest ranked non-locally stored media item 40 may be determined based on the change in the user preferences (step 502).

If the user preferences did not change, the monitor may then determine if a non-locally stored media item 40 was not available for playing as scheduled (decision point 508). The central server 12 may not have been able to download the non-locally stored media item 40 to the user device 14 within the time constraint 44, and therefore, the scheduled playing time of the non-locally stored media item 40 may have been missed. The user device 14 may then move the media item recommendation corresponding to the missed non-locally stored media item 40 down by one position in the playlist 28. In such an event, the missed non-locally stored media item 40 will be the next media item to be played by the user device 14 after the playing of the currently playing media item is completed. This event causes the positions of the media item recommendations in the playlist 28 to change. Therefore, the highest ranked non-locally stored media item 40 may be determined based on the change in the positions of the media item recommendations in the playlist 28 (step 502).

If the non-locally stored media items 40 have been available for playing as scheduled, the monitor may then determine if the user of the user device 14 used any transport commands such as fast forward “FF,” re-wind “RW,” and/or “pause,” for example, during the playing of a media item (decision point 510). If the user did use any such transport commands, the actual playing time of the media item may have been changed and, therefore, the time constraint 44 of the non-locally stored media items 40 may be affected. Therefore, the highest ranked non-locally stored media item 40 may be determined based on the user using transport commands (step 502).

If the user did not use any such transport commands, the monitor may then determine if the network connection for the user device 14 changed (decision point 512). If the network data connection changed, then the network data rate 50 for the user device 14 may change. The changed network data rate 50 may affect the manner in which the central server 12 may schedule the downloading of non-locally stored media items 40 to the user device 14. This may be particularly affect the simultaneous downloading of more than one non-locally stored media item 40. Therefore, the highest ranked non-locally stored media item 40 may be determined based on the change to the network connection (step 502). If the network connection did not change, the process continues monitoring in the sequence discussed above.

As discussed above, if any of the events with respect to decision points 504-512 occurred, the highest ranked non-locally stored media item 40 may be determined based on those events (step 502). A determination may then be made whether the ranking has changed for a top certain number, designated as “M,” of non-locally stored media items 40 (decision point 514). As examples, the designation “M” may be any number, such as the top “5” non-locally stored media items 40 or the top “10” non-locally stored media items 40 in the playlist 28. However, the present invention is not limited to any specific number for the designation “M.” If such a ranking has not changed, the process continues monitoring in the sequence discussed above, but, in addition, a new download prioritization message 34 may be sent (step 516).

If the ranking of the top “M” non-locally stored media items 40 has changed, new or updated time constraints 44 and estimated download times for the top “M” non-locally stored media items 40 may be computed (step 518). The estimated download speed of the top “M” non-locally stored media items 40 may then be computed (step 520), and a new download prioritization message 34 may be sent (step 516).

If the non-locally stored media item 40 was not available for playing as scheduled (decision point 508), the time constraint 44 for that non-locally stored media item 40 may be set to “0” in step 518. In this manner, an indication may be provided to the central server 12 that downloading the non-locally stored media item 40 should be prioritized above other non-locally stored media items 40 due to the fact that the user device 14 has been and/or may be in danger of being disrupted.

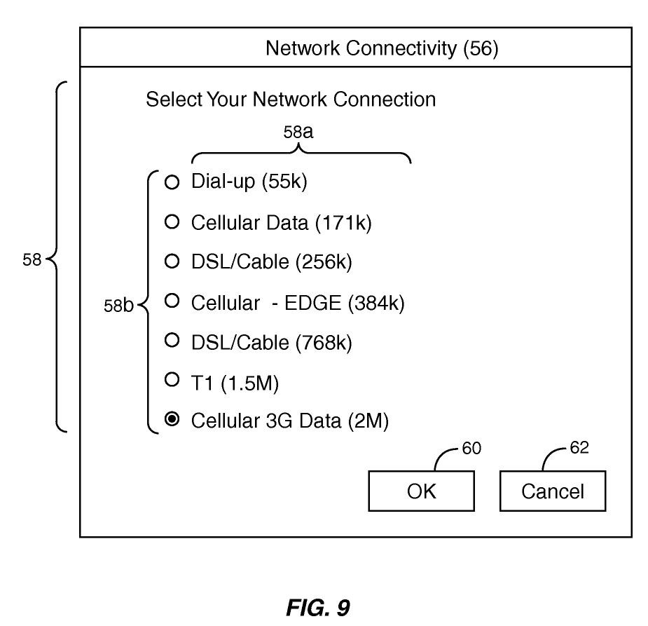

The user of the user device 14 may initially establish and/or change the network connection, and therefore, the network data rate 50. FIG. 9 illustrates a network connectivity graphical user interface (GUI) 56 which allows the user to initially set and/or change the network connection of the user device 14, according to one embodiment of the present invention.

The network connectivity GUI 56 includes a list of network connection choices 58 under the text heading “Select Your Network Connection.” Each network connection choice 58 may include a description of the connection with an associated data rate 58a, and a selector 58b for choosing the particular network connection 58. The selector 58b is shown as a radio button, but the present invention is not limited to any particular type of selector 58b. Additionally, the number and types of network connection choices 58 listed in the network connectivity GUI 56 is exemplary only and does not limit the present invention in any manner.

As an example, the user has selected a Cellular 3G Data connection with a data rate of 2M, or two megabits/second. If the user is satisfied with that selection, the user may actuate an “OK” button 60, and the user device 14 may be provisioned for that network connection choice 58 and the network data rate 50 in the download prioritization message 34 may include the data rate corresponding to the network connection choice 58 selected, in this example two megabits/second. The network connectivity GUI 56 may also close upon the user actuating the “OK” button 60. Conversely, if the user is not satisfied with the network connection choice 58 selected, the user may actuate a “Cancel” button 62. In such a case, the network connectivity GUI 56 may close and the existing network connection may be retained.

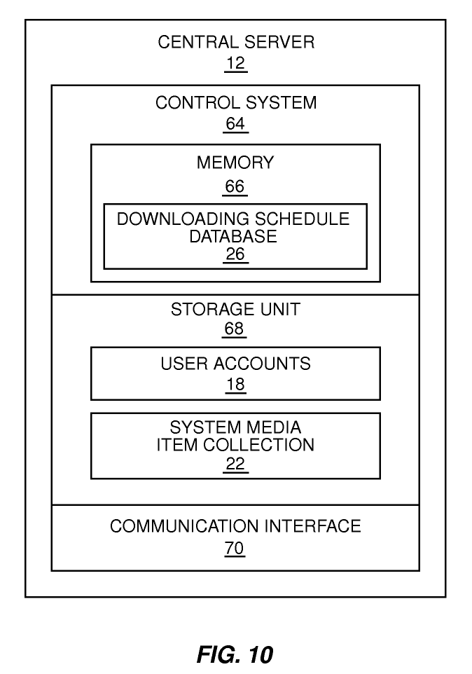

FIG. 10 is a block diagram illustrating more detail regarding the exemplary components that may be provided by the central server 12 of FIG. 1 to perform the present invention. In general, the central server 12 may be processor or microprocessor-based, and may also include a control system 64 having associated memory 66. The downloading schedule database 26 may be at least partially implemented in software and stored in the memory 66. The central server 12 may also include a storage unit 68 operating to store the user accounts 18 and the system media item collection 22. The storage unit 68 may also store the downloading schedule database 26. The storage unit 68 may be any number of digital storage devices such as, for example, one or more hard-disc drives, one or more memory cards, Random Access Memory (RAM), one or more external digital storage devices, or the like. The user accounts 18 and the system media item collection 22 may alternatively be stored in the memory 66. A communication interface 70 may include a network interface allowing the central server 12 to be communicably coupled to a network 16.

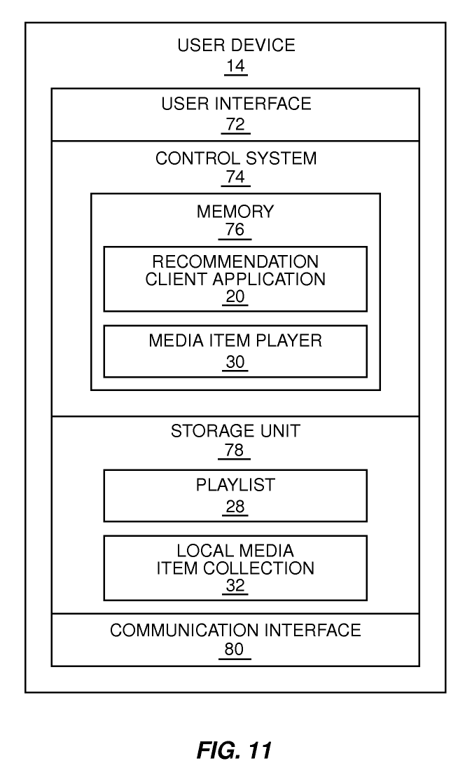

FIG. 11 is a block diagram illustrating more detail regarding the exemplary components that may be provided within the user device 14 of FIG. 1 to provide the present invention. In general, the user device 14 may be any type of computing device that is capable of performing communications over the network 16 to reach the central server 12 and other user devices 14. Examples of user devices 14 include, but are not limited to: home computers; computers at work; laptop computers; wireless portable media player (PMP) devices; hand-held computer devices, such as personal digital assistants (PDAs) with remote communication capabilities; cell phones; and the like.

To provide for the foregoing and to perform the processes and functions described herein, the user device 14 may be processor or microprocessor-based and may also include a user interface 72. The user interface 72 may be used to interface with components such as a display, speakers, a user input device, and the like. The user device 14 also includes a control system 74 having associated memory 76. In this example, the recommendation client application 20 and the media item player 30 are at least partially implemented in software and stored in the memory 76. The user device 14 also includes a storage unit 78 operating to store the playlist 28 and the local media item collection 32. The storage unit 78 may be any number of digital storage devices such as, for example, one or more hard-disc drives, one or more memory cards, RAM, one or more external digital storage devices, or the like. The playlist 28 and the local media item collection 32 may alternatively be stored in the memory 76. The user device 14 also includes a communication interface 80. The communication interface 80 may include a network interface for communicatively coupling the user device 14 to the network 16.

The functionality of the present invention can be embodied in any computer-readable medium for use by or in connection with a computer-related system or method. In the context of the present invention, a computer-readable medium is an electronic, magnetic, optical, semiconductor, or other device or means that can transmit, contain, or store computer instructions, programs, or data for use by or in connection with a computer-related system or method.

Those skilled in the art will recognize improvements and modifications to the preferred embodiments of the present invention. All such improvements and modifications are considered within the scope of the concepts disclosed herein and the claims that follow.

What is claimed is:

1. A method of prioritizing the downloading of a media item, comprising the steps of:
receiving a request to download a recommended media item from a user device; and
determining a priority for downloading the recommended media item to the user device.

2. The method of claim 1, wherein the request comprises a time constraint, and wherein the determining the priority for downloading the recommended media item is a function of the time constraint.

3. The method of claim 2, wherein the time constraint comprises an amount of time before the recommended media item is to be used on the user device.

4. The method of claim 2, wherein the time constraint comprises an amount of time between a first time at which the request is sent from the user device and a second time at which the recommended media item is estimated to be used on the user device.

5. The method of claim 2, wherein the time constraint is a function of a user-specific rank of the recommended media item on the user device.

6. The method of claim 1, further comprising scheduling the downloading of the recommended media item by listing the recommended media item in a downloading schedule based on the determined priority.

7. The method of claim 6, wherein the determining the priority is a function of a scheduling constraint, and wherein the scheduling constraint is a function of a time constraint included in the request.

8. The method of claim 7, further comprising determining a probable downloading time for the recommended media item, wherein the scheduling constraint comprises the time constraint less the probable downloading time.

9. The method of claim 8, wherein the probable downloading time for the recommended media item is a function of at least one factor selected from a group consisting of: a size of the recommended media item, a network connection data rate associated with the user device, an estimated downloading speed of the recommended media item, and an amount of time to download the recommended media item from another media source.

10. The method of claim 7, further comprising:
receiving a new request from the user device to download the recommended media item, wherein the new request further comprises an updated time constraint for downloading the recommended media item to the user device;
determining an updated scheduling constraint, wherein the updated scheduling constraint is a function of the updated time constraint; and
determining an updated priority for the downloading of the recommended media item based on the updated scheduling constraint.

11. The method of claim 6, wherein the scheduling the downloading of the recommended media item further comprises listing the recommended media item in a downloading schedule.

12. The method of claim 11, wherein the listing the recommended media item in the downloading schedule based on the determined priority comprises:
comparing the determined priority to a second priority associated with a second recommended media item scheduled for downloading; and
listing the recommended media item in the downloading schedule based on the comparison.

13. The method of claim 6, further comprising downloading the recommended media item to the user device when scheduled for downloading according to the downloading schedule.

14. The method of claim 1, wherein the receiving a request from a user device to download a recommended media item comprises receiving a request from a user device to download a plurality of recommended media items, and wherein the request comprises a plurality of time constraints, each time constraint being associated with a respective one of the plurality of recommended media items.

15. The method of claim 1, wherein the recommended media item is recommended to the user device from a recommender.

16. A device adapted to prioritize the downloading of a media item, comprising:
a media server, wherein the media server is adapted to:
receive a request to download a recommended media item from a user device; and
determine a priority for downloading of the recommended media item to the user device.

17. The device of claim 16, wherein the request comprises a time constraint, and wherein the media server is adapted to determine the priority for downloading of the recommended media item as a function of the time constraint.

18. The device of claim 17, wherein the time constraint comprises an amount of time between a first time at which the request is sent from the user device and a second time at which the recommended media item is estimated to be used on the user device.

19. The device of claim 16, wherein the media server is further adapted to schedule the downloading of the recommended media item by listing the recommended media item in a downloading schedule based on the determined priority.

20. The device of claim 16, wherein the determined priority is a function of a scheduling constraint, and wherein the scheduling constraint is a function of a time constraint included in the request.

21. The device of claim 16, wherein the request further comprises information comprised from a group consisting of: a media item list size, a media item list, a user identifier, an estimated download speed, and a network data rate.

22. The device of claim 17, wherein the media server is further adapted to:
receive a new request to download the recommended media item from the user device, wherein the download request further comprises an updated time constraint for downloading the recommended media item to the user device; and
determine an updated priority for the downloading of the recommended media item based on the updated scheduling constraint.

23. A method of requesting downloading of a media item, comprising the steps of:
receiving a media item recommendation at a user device;
determining a time constraint for the media item recommendation as a function of an estimated amount of time before a recommended media item is to be used by the user device;
determining if a media item corresponding to the media item recommendation is locally stored at the user device; and
sending a request to a media server to request downloading of the media item if the media item is not locally stored at the user device, wherein the request further comprises the time constraint.

24. The method of claim 23, further comprising:
determining if the recommended media item was received in accordance with the time constraint; and
noting the recommended media item as a missed media item if the recommended media item was not received in accordance with the time constraint.

25. The method of claim 24, further comprising sending another download request to the media server to request downloading of the missed media item, wherein the another download request further comprises an updated time constraint.
